(19) United States
(12) Patent Application Publication
(10) Pub. No.: US 2021/0035252 A1
(43) Pub. Date: Feb. 4, 2021

(54) DETERMINING DISUTILITY OF SHARED TRANSPORTATION REQUESTS FOR A TRANSPORTATION MATCHING SYSTEM

(71) Applicant: Lyft, Inc., San Francisco, CA (US)

(72) Inventors: Matthew Ezra Leventi, Seattle, WA (US); Bobak Moallemi, Berekly, CA (US); Venkata Subbiah Sarma Tangirala, San Francisco, CA (US); Garrett van Ryzin, Brooklyn, NY (US); Irena Stephanie Vezich, San Francisco, CA (US)

(21) Appl. No.: 16/530,797

(22) Filed: Aug. 2, 2019

(51) Int. Cl. G06Q 50/30; G06Q 30/02; G06N 20/00

(52) U.S. Cl. CPC G06Q 50/30; G06N 20/00; G06Q 30/0284

(57) ABSTRACT

This disclosure covers computer-implemented methods, non-transitory computer readable media, and systems that determine disutility metrics for transportation requests in a shared transportation. For example, the disclosed systems determine estimated service metrics for a plurality of combinations of one or more transportation requests in the shared transportation (e.g., an estimated amount of time to perform a transportation service for a combination of one or more transportation requests). Additionally, the disclosed systems analyze the estimated service metrics to determine an effect of the transportation requests on a combined service metric for the shared transportation and then determine disutility metrics for the transportation requests based on the determined effect. The disclosed systems then generate messages including information associated with the disutility metrics for displaying at requester devices associated with the transportation requests.

### BACKGROUND

In recent years, popularity and usage of on-demand transportation matching systems have significantly grown. Indeed, the proliferation of web and mobile applications easily enable requesting individuals to request transportation from one geographic area to another geographic area. For instance, an on-demand transportation matching system receives transportation requests and pairs the requests with providers that can transport requesting individuals to the destination locations. In addition, the on-demand transportation matching system provides tools to providers to pick up requesting individuals as well as transport them to the destination locations.

Sometimes, on-demand transportation matching systems provide shared transportations for individuals in which the individuals share a transportation vehicle with each other. While shared transportations are typically more efficient for transportation providers, shared transportations can often be less efficient for one or more requesting individuals involved in the shared transportations. For instance, sharing a single transportation vehicle among several individuals can introduce routing detours to pick up and/or drop off one or more additional individuals, particularly for individuals that a transportation provider first picked up for the shared transportation. Shared transportations can thus increase a transportation time/distance for one or more of the requesting individuals.

Some on-demand transportation matching systems attempt to increase the number of shared transportations by allowing individuals to share costs associated with the shared transportations. Conventional systems, however, do not take into account different amounts of inefficiency that different requesting individuals experience in shared transportations. Because conventional systems fail to account for individual inefficiencies in shared transportations, individuals are less likely to request shared transportations, resulting in greater inefficiencies in the transportation system overall. In particular, fewer shared transportations results in more individual transportations, greater wait times for requesting individuals, and increased resource usage by transportation providers.

These and other problems exist with conventional transportation matching systems.

### SUMMARY

This disclosure describes one or more embodiments of methods, non-transitory computer readable media, and systems that solve the foregoing problems in addition to providing other benefits. While this summary refers to systems for simplicity, the summary also applies to certain disclosed methods and non-transitory computer readable media. To solve the foregoing and other problems, the disclosed systems identify a shared transportation involving a plurality of transportation requests associated with a plurality of requester devices. The disclosed systems use estimated service metrics corresponding to combinations of the transportation requests to determine an effect of the transportation requests on a combined service metric associated with the shared transportation. The disclosed systems then use the effect of the transportation requests on the combined service metric to determine disutility metrics for the transportation requests. In response to determining disutility metrics for the transportation requests, the disclosed systems generate messages including information about the disutility metrics for displaying at requester devices.

Additional features and advantages of one or more embodiments of the present disclosure will be set forth in the description which follows, and in part will be obvious from the description, or may be learned by the practice of such example embodiments.

### BRIEF DESCRIPTION OF THE DRAWINGS

The detailed description refers to the drawings briefly described below.

FIG. 1 illustrates a block diagram of an environment for implementing a transportation matching system in accordance with one or more embodiments.

FIGS. 2A-2B illustrates embodiments of shared transportations including a plurality of transportation requests in accordance with one or more embodiments.

FIG. 3 Illustrates a graphical user interface of a requester client device presenting information for a shared transportation in accordance with one or more embodiments.

FIGS. 4A-4D Illustrate experimental data for shared transportations in accordance with one or more embodiments.

FIG. 5 illustrates a flowchart of a series of acts in a method of modifying transaction requests based on surplus metrics in accordance with one or more embodiments.

FIG. 6 illustrates a block diagram of a computing device in accordance with one or more embodiments.

FIG. 7 illustrates an example environment for a transportation matching system in accordance with one or more embodiments.

### DETAILED DESCRIPTION

One or more embodiments of the present disclosure include a transportation matching system that determines disutility metrics for requesters of shared transportations. In particular, the transportation matching system determines an effect of each transportation request on a shared transportation. More specifically, the transportation matching system determines the estimated service metrics for combinations of one or more transportation requests of the shared transportation. The transportation matching system then determines the effect of each of the transportation requests on a combined service metric for the shared transportation based on the estimated service metrics of the various combinations of one or more transportation requests. Furthermore, the transportation matching system determines disutility metrics for the transportation requests based on the effect of the transportation requests on the combined service metric and then generates messages to send to requester devices including information about the disutility metrics. By determining disutility metrics for the transportation requests corresponding to a shared transportation, the transportation matching system can take into account the disutility to each requester of adding additional requesters to a shared transportation.

In one or more embodiments, the transportation matching system identifies a shared transportation for a plurality of transportation requests. For instance, the transportation matching system can receive a plurality of transportation requests from a plurality of requester devices. The transportation requests can be part of, or otherwise associated with, a request for a shared transportation involving a plurality of requesters. Thus, the shared transportation can include requests to share a transportation vehicle during all or part of the separate transportation requests.

According to one or more embodiments, the transportation matching system determines a plurality of estimated service metrics corresponding to combinations of one or more transportation requests in the shared transportation. In particular, the transportation matching system 102 can analyze possible combinations of transportation requests from the shared transportation (e.g., all the possible route combinations involving one or more requesters associated with the shared transportation) to determine estimated service metrics for the combinations. The transportation matching system can thus determine estimated times, distances, and/or other metrics associated with possible transportation request combinations for a shared ride.

In one or more embodiments, the transportation matching system analyzes estimated service metrics for combinations of transportation requests to determine an effect of each request on a combined service metric associated with a shared transportation. Specifically, the transportation matching system can determine how much of an extra burden is being placed on one or more individual transportation requests in response to adding one or more transportation requests to a shared transportation. To illustrate, the transportation matching system can accordingly determine whether a transportation request of a first requester (e.g., a requester with the first pickup location) has a modified time, distance, or other metric in response to adding one or more additional transportation requests to the first requester's request. For example, the transportation matching system determines the effect of each request in a shared transportation by analyzing the estimated service metrics to generate Shapley values for the requests.

Once the transportation matching system has determined an effect of transportation requests on a combined service metric, the transportation matching system determines disutility metrics for the transportation requests. In particular, the transportation matching system can determine a disutility for each transportation request based on other transportation requests from the shared transportation. For example, transportation requests can add additional time, distance, etc., to a shared transportation as a whole when adding additional requesters to the shared transportations by requiring the provider to move to additional pickup locations or destination locations.

In one or more embodiments, the transportation matching system then provides the disutility information to the requester devices. Specifically, the transportation matching system can generate messages to send to the individual requester devices based on the corresponding disutility metrics. For instance, the transportation matching system generates, for a given requester, an electronic message with transportation request information and includes information about a disutility metric for the transportation request. The transportation matching system can send the electronic message to a requester device corresponding to the transportation request, causing the requester device to display the information about the disutility metric in connection with completion of the transportation request within a requester application.

As previously mentioned, the transportation matching system described herein provides advantages over conventional transportation matching systems. In particular, the transportation matching system described below improves the efficiency of a computing system implementing the transportation matching system by generating disutility metrics for shared transportations involving a plurality of requester devices based on the effects of individual transportation requests on the shared transportations. The transportation matching system can apply disutility metrics to transportation requests in a shared transportation, which increases the likelihood of subsequent shared transportations.

Additionally, determining and using disutility metrics for transportation requests associated with shared transportations reduces processing loads on the computing system. Specifically, using disutility metrics as described herein increases the likelihood of requesters using shared transportations, which increases the efficiency of transportation requests by performing a plurality of transportation requests simultaneously. Performing a plurality of requests in conjunction also improves availability of transportation providers, thereby reducing the wait time for requesters seeking transportation.

Furthermore, determining disutility metrics for transportation requests also allows the transportation matching system to improve accuracy in the computing system when matching providers with requesters in subsequent shared transportations. For instance, by analyzing the effect of transportation requests on a shared transportation, the transportation matching system can train a machine-learning model to match transportation requests together while limiting significant discrepancies between disutility metrics of the transportation requests. This can thus improve the match efficiency of the computing systems by pairing transportation requests that have lower impacts on other transportation requests.

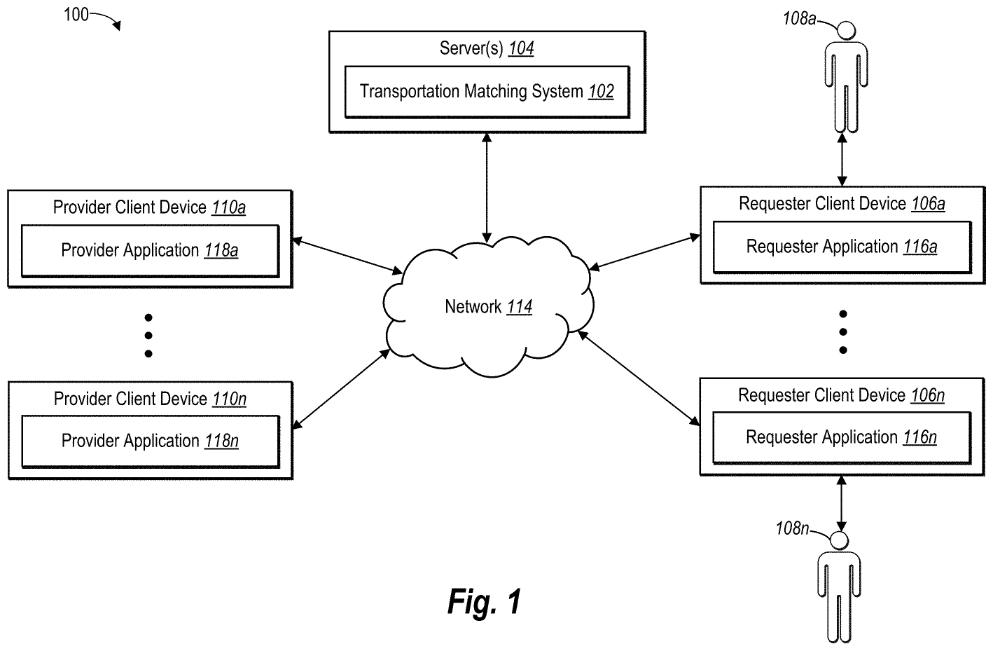

Turning now to the figures, FIG. 1 illustrates a schematic diagram of an environment 100 for implementing a transportation matching system 102 in accordance with one or more embodiments. This disclosure provides an overview of the transportation matching system 102 with reference to FIG. 1. After providing an overview, the disclosure describes components and processes of the transportation matching system 102 in further detail with reference to subsequent figures.

As shown, FIG. 1 illustrates an example environment 100 for a transportation matching system 102 implemented on one or more server(s) 104. The environment 100 further includes requester client device 106a-106n associated with requesters 108a-108n and provider client devices 110a-110n associated with transportation providers 112a-112n. As further shown in FIG. 1, the requester client devices 106a-106n and the provider client devices 110a-110n communicate with the transportation matching system 102 and/or each other via a network 114. Furthermore, as illustrated, the requester client devices 106a-106n include requester applications 116a-116n, and the provider client devices 110a-110n include provider applications 118a-118n.

As used herein, the term “requester” refers to person (or group of people) who requests a ride or other form of transportation from a transportation matching system. A requester may refer to a person who requests a ride or other form of transportation but who is still waiting for pickup. A requester may also refer to a person whom a transportation vehicle has picked up and who is currently riding within the transportation vehicle to a destination (e.g., a destination indicated by a requester). As shown in FIG. 1, each of the requesters 108a-108n are respectively associated with the requester client devices 106a-106n.

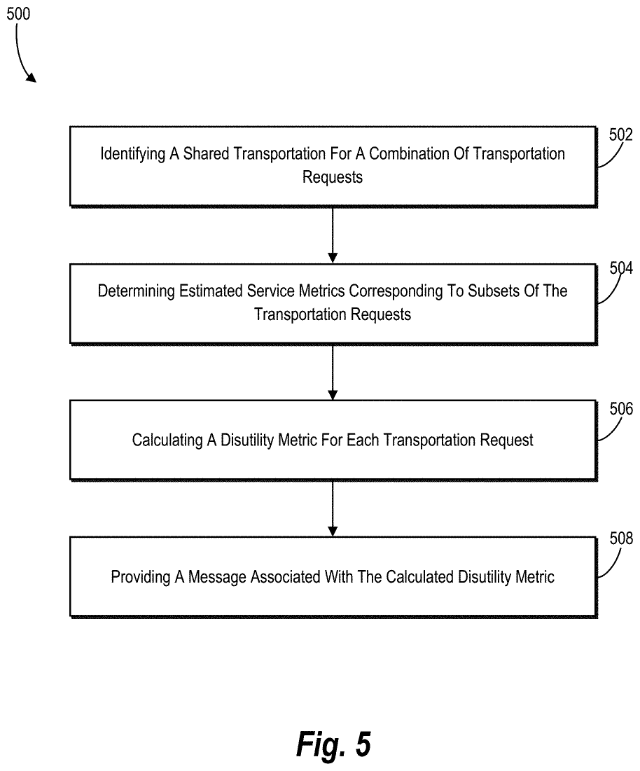

Accordingly, the terms “requester client device” and “requester device” refer to a computing device associated with a requester and which allows the requester to send a transportation request to the transportation matching system 102. A requester client device can include a mobile device such as a laptop, smartphone, or tablet associated with a requester, though the requester client devices 106a-106n may be any type of computing device, as further explained below with reference to FIG. 5. Each of the requester client devices 106a-106n respectively include requester applications 116a-116n to facilitate a transportation request. As used herein, the term “transportation request” refers to a request by a requester to transport the requester from a first location to a second location. In one or more embodiments, the requester applications 116a-116n include web browsers, applets, or other software applications (e.g., native applications) available to the requester client devices 106a-106n.

As shown in FIG. 1, a requester (e.g., requester 108a) may use a requester application 116a on requester client device 106a to request transportation services, receive a price or a price estimate for the transportation service, and access other transportation-related services. For example, the requester 108a may interact with the requester client device 106a through graphical user interfaces of the requester application 116a to enter a pickup location and a destination for transportation. The transportation matching system 102 can in turn provide, via the network 114, the requester client device 106a with a message including, for example, a price (or price estimate) for the transportation and an estimated time of arrival of a provider (or transportation vehicle) through the requester application 116a. Having received the message from the transportation matching system 102, the requester 108a may then select an option to request transportation services from the transportation matching system 102.

In one or more embodiments, the network 114 shown in FIG. 1 may include one or more networks and may use one or more communication platforms or technologies suitable for transmitting data and/or communication signals. In one or more embodiments, the network 114 includes a cellular network. Additionally, or alternatively, the network 114 can include the Internet or World Wide Web. Additionally, or alternatively, the network 114 can include various other types of networks that use various communication technologies and protocols, such as a corporate intranet, a virtual private network (“VPN”), a local area network (“LAN”), a wireless local network (“WLAN”), a wide area network (“WAN”), a metropolitan area network (“MAN”), or a combination of two or more such networks.

After receiving a transportation request from a requester client device, the transportation matching system 102 performs an operation to match the transportation request to a transportation provider. In particular, the transportation matching system 102 can determine a plurality of available transportation providers by communicating with the provider client devices 110a-110. For example, the transportation matching system 102 communicates with the provider client devices 110a-110n and the requester client devices 106a-106n via the network 120 to determine locations of the provider client devices 110a-110n and the requester client devices 114a-114n, respectively. The transportation matching system 102 can then select a provider client device (e.g., based on geographic proximity, requester preferences, transportation type, transportation routing) from the plurality of provider client devices 110a-110 and send the transportation request to the selected provider client device.

As used herein, the terms “transportation provider” and “provider” refer to a driver, other person, or automated system that operates a transportation vehicle and/or who interacts with a provider client device. For instance, a provider includes a person who drives a transportation vehicle along various routes to pick up and drop off requesters. Alternatively, a provider can include an autonomous transportation vehicle—that is, a self-driving vehicle that includes computer components and accompanying sensors for driving without manual-provider input from a human operator. When a transportation vehicle is an autonomous vehicle, the transportation vehicle may include additional components such as location components, one or more sensors by which the autonomous vehicle navigates, and/or other components necessary to navigate without a human operator (or with minimal interactions by a human operator).

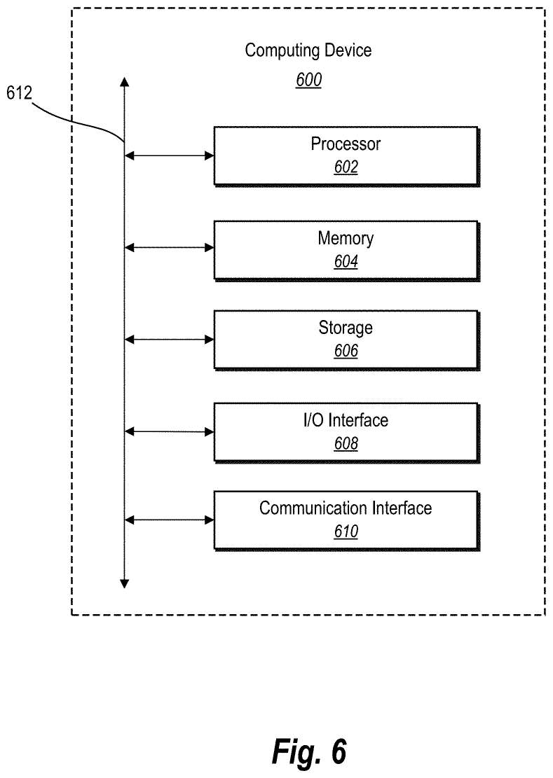

Also as used herein, the terms “provider client device” and “provider device” refer to a computing device associated with a provider and which allows the provider to receive transportation requests from the transportation matching system 102. For example, a provider device may refer to a separate mobile device, such as a laptop, smartphone, or tablet associated with the transportation provider, though the provider client devices 110a-110n may be any type of computing device as further explained below with reference to FIG. 6. Additionally, or alternatively, a provider device may be a subcomponent of a vehicle computing system, such as a vehicle computing system for autonomous vehicles. Regardless of its form, the provider client devices 110a-110n may include various sensors, such as a GPS locator, an inertial measurement unit, an accelerometer, a gyroscope, a magnetometer, and/or other sensors that the transportation matching system 102 can access to obtain information (e.g., location information).

As mentioned previously, the provider client devices 110a-110n respectively include provider applications 118a-118n. In some embodiments, the provider applications 118a-118n comprise web browsers, applets, or other software applications (e.g., native applications) available to the provider client devices 110a-110n. Additionally, in some instances, the transportation matching system 102 provides data packets including instructions that, when executed by the provider client devices 110a-110n, create or otherwise integrate provider applications 118a-118n within an application or webpage.

As mentioned, the server(s) 104 can include the transportation matching system 102. In particular, the transportation matching system 102 provides functionality to match transportation requests received from requester client devices to provider computing devices. Matching transportation requests can also include matching a plurality of transportation requests from a plurality of requester client devices to a single provider computing device in a shared transportation. As used herein, the term “shared transportation” refers to a transportation involving a plurality of requesters in a plurality of overlapping transportation requests. For instance, two or more requesters can share a transportation vehicle for at least a portion of their respective transportation services. Accordingly, a provider can pick up a first requester and then pick up a second requester prior to dropping off the first requester. A shared transportation can also include dropping off one or more requesters and picking up one or more additional requesters until a final requester is dropped off at a destination, at which time the shared transportation ends.

Additionally, as discussed in more detail below, the transportation matching system 102 analyzes fulfilled (e.g., completed) transportation requests associated with shared transportations to determine disutility associated with each transportation request. Indeed, the transportation matching system 102 communicates with a provider client device (e.g., provider client device 110a) to obtain transportation data from a plurality of fulfilled transportation requests associated with a shared transportation to generate disutility metrics for each transportation request. Furthermore, the transportation matching system 102 can also use information about the disutility metrics to provide messages to requester client devices corresponding to the shared transportation and/or to modify transportation requests. The transportation matching system 102 can further use disutility metrics in predicting disutility metrics or in matching requesters to providers about future shared transportations (e.g., using a machine-learning model). To illustrate, the transportation matching system 102 can use historical disutility metrics and other historical transportation data to provide expected disutility and transportation data for future shared transportations.

As used herein, the term “disutility metric” refers to a measurement for a transportation request indicating a detour experienced by a transportation request based on one or more other transportation requests in a shared transportation. For instance, a disutility metric can represent, but is not limited to, an amount of time or distance added to a shared transportation for a requester in response to adding one or more additional requesters to the shared transportation. The transportation matching system 102 can use a disutility metric associated with a particular transportation request based on one or more other transportation requests to determine a cost to allocate to a requester of the particular transportation request.

As used herein, the term “estimated service metric” refers to a predicted characteristic of a transportation service corresponding to a transportation request. Specifically, the transportation matching system 102 can predict one or more characteristics associated with a provider performing a transportation service in response to a transportation request. To illustrate, an estimated service metric can include an estimated time for fulfilling a transportation request (e.g., the predicted amount of time to travel from a pickup location to a destination location) based on distance, traffic, speed limits, etc. Also as used herein, the term “pickup location” refers to a location of pickup of a requester of a transportation request. For instance, a pickup location can include a location where a requester enters a vehicle of a transportation provider. As used herein, the terms “destination location” and “dropoff location” refer to a location for completing a transportation request. For example, a destination location can include a location where a requester exits a vehicle of a transportation provider.

As used herein, the term “combined service metric” refers to a characteristic of a fulfilled shared transportation. In particular, the transportation matching system 102 can determine one or more characteristics associated with fulfilling a shared transportation. For instance, a combined service metric can include a total amount of time to fulfill a completed shared transportation (e.g., the actual amount of time a transportation vehicle moved from a first pickup location to a final destination location associated with a plurality of transportation requests in the shared transportation). Accordingly, a combined service metric can represent the same (or similar) type of data that estimated service metrics represent (e.g., movement time for transportation services).

As used herein, the term “service allocation metric” refers to a value allocated to a transportation provider in connection with a particular transportation request. For instance, the transportation matching system 102 can determine a cost that is allocated to a transportation provider for each transportation request based on estimated distances or times associated with the transportation requests in the shared transportation. Additionally, as used herein, the term “match efficiency metric” refers to a value representing a quality of a match involving one or more transportation requests and a transportation provider. Specifically, a match efficiency can include a ratio of a transportation service route cost relative to a cost to the transportation matching system 102. Accordingly, the transportation matching system 102 can determine costs associated with a shared transportation for use in matching future transportations requests together in shared transportations.

In one or more embodiments, the provider client devices 110a-110n provide transportation data for shared transportations involving the requester client devices 106a-106n to the transportation matching system 102 prior to, during, and/or after performance of the shared transportations. The transportation matching system 102 can use the transportation data to generate the metrics described previously (e.g., service allocation metrics, estimated service metrics, combined service metrics, disutility metrics, match efficiency metrics). The transportation matching system 102 can use the metrics to determine costs for transportation requests, matching of requests to the provider client devices 110a-110n, training of machine-learning models, predictions for subsequent requests, etc. Additionally, the transportation matching system 102 can generate messages to provide to the provider client devices 110a-110n and/or the requester client devices 106a-106n including information about the metrics such as the disutility metrics.

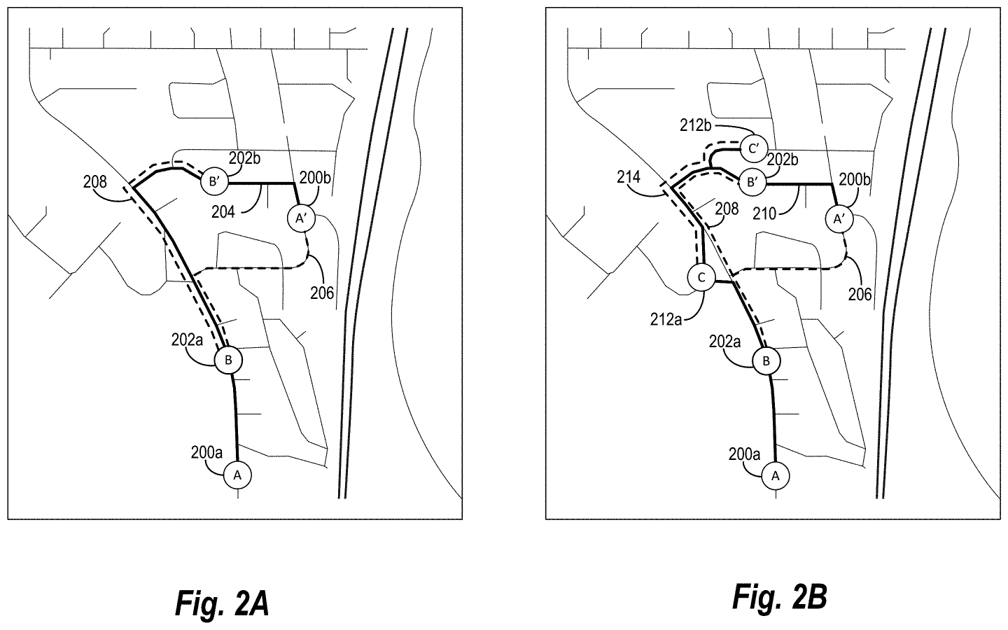

As described briefly above, the transportation matching system 102 uses information about shared transportations to determine disutility associated with transportation requests in the shared transportations. FIG. 2 illustrates embodiments of shared transportations including a plurality of transportation requests. In particular, FIG. 2A illustrates a set of transportation requests in a shared transportation. FIG. 2B illustrates the set of transportation requests including an additional transportation request for the shared transportation.

As described previously, the transportation requests represent requests that the transportation matching system 102 receives from a plurality of different requester client devices. For example, FIGS. 2A-2B illustrate map diagrams including transportation requests from a plurality of requester client devices in connection with shared transportations. The transportation matching system 102 can also provide information about the requests to a provider client device to allow the corresponding provider to fulfill the shared transportations.

In one or more embodiments, as shown in FIG. 2A, the transportation matching system 102 receives a first transportation request associated with a first requester client device. The first transportation request includes a first pickup location 200a and a first destination location 200b for transporting a first requester. The transportation matching system 102 also receives a second transportation request associated with a second requester client device. The second transportation request includes a second pickup location 202a and a second destination location 202b for transporting a second requester. Additionally, each transportation request can include an indication that the transportation request is a shared request (e.g., that the request is willing to share the transportation vehicle for at least a portion of a transportation service).

After receiving one or more transportation requests for a shared transportation from a plurality of requester client devices, the transportation matching system 102 then matches the transportation request(s) to a provider client device. To illustrate, the transportation matching system 102 can match the transportation request to a provider client device that is near a pickup location of the transportation request or that will be near the pickup location after completing an ongoing transportation request. Furthermore, the transportation matching system 102 can match a plurality of transportation requests in a shared transportation to a provider client device based on proximity of pickup locations, destination locations, availability of providers, distances, estimated times, traffic, or other characteristics of the requests, providers, or other systems/entities that may affect fulfillment of a transportation request.

In one or more embodiments, the transportation matching system 102 can match the second transportation request to the provider client device after matching the first transportation request to the provider client device. For example, the transportation matching system 102 can match the first transportation request to the provider client device after receiving the first transportation request and then match the second transportation request to the provider client device after receiving an acceptance of the first transportation request from the provider client device. Furthermore, the transportation matching system 102 can match the second transportation request to the provider client device even after the provider has started transporting the first requester (e.g., after pickup up the first requester and before reaching a pickup location of the second requester device).

Furthermore, the transportation matching system 102 can provide information to the provider client device associated with the shared transportation. For example, the transportation matching system 102 can provide one or more of the pickup locations of the transportation requests to the provider client device. Additionally, the transportation matching system 102 can provide routing information between the first pickup location 200a and the second pickup location 202a, and to one or more of the destination locations. To illustrate, when matching a plurality of transportation requests to a provider client device in connection with a shared transportation, the transportation matching system 102 can determine a shared transportation route 204 that includes the plurality of transportation requests.

The transportation matching system 102 can determine a shared transportation route 204 for a shared transportation based on the first transportation request and the second transportation request. As mentioned, the first transportation request includes a request to transport a first requester from the first pickup location 200a to the first destination location 200b. Additionally, the second transportation request includes a request to transport a second requester from the second pickup location 202a to the second destination location 202b. Accordingly, the transportation route for the shared transportation includes the pickup locations and destination locations for the first transportation request and the second transportation request.

In one or more embodiments, the transportation matching system 102 receives the transportation requests for the shared transportation in any order. For instance, the transportation matching system 102 can receive the first transportation request prior to or after receiving the second transportation request. Additionally, the transportation matching system 102 can receive the transportation requests in a shared transportation before the provider begins fulfilling the shared transportation. Alternatively, the transportation matching system 102 can receive one or more transportation requests for a shared transportation during fulfillment of the shared transportation (e.g., while the provider is driving to a pickup location of a requester or on route to a destination location of a requester).

The transportation matching system 102 can determine a plurality of metrics associated with the shared transportation and corresponding transportation requests. For instance, the transportation matching system 102 can estimate distances, travel times, and costs (e.g., to the transportation provider and/or the transportation matching system 102) associated with the transportation requests. To illustrate, the transportation matching system 102 can determine an estimated service metric for a transportation request that indicates a predicted amount of time to fulfill the transportation request (e.g., the estimated drive time along a route between the pickup location and destination location of the request). In one or more embodiments, the transportation matching system 102 determines the estimated service metric for a transportation request that corresponds to a subset of requesters associated with the shared transportation. In particular, the estimated service metric represents a particular characteristic of a combination of one or more transportation requests in the shared transportation. As mentioned, in addition to, or instead of, determining estimating service metrics representative of predicted travel times associated with transportation requests, the transportation matching system 102 can determine metrics such as, but not limited to, values representing distance, cost, comfort, or enjoyment (e.g., based on ratings or other feedback from a requester).

As an illustration, the transportation matching system 102 can determine a first estimated service metric for the first transportation request. For example, the transportation matching system 102 can determine an estimated amount of time to travel from the first pickup location 200a to the first destination location 200b along a transportation route corresponding to the first transportation request. In one or more embodiments, as shown, without taking into account the second transportation request, the first transportation request follows a first transportation route 206 (e.g., the shortest, most direct, or most likely route) from the first pickup location 200a to the first destination location 200b. The transportation matching system 102 can thus determine the estimated amount of time based on speed limits, current traffic, historical data associated with the first transportation route 206, historical data associated with the provider, etc.

The transportation matching system 102 can also determine a second estimated service metric for the second transportation request. In particular, the transportation matching system 102 can determine an estimated amount of time to travel from the second pickup location 202a to the second destination location 202b along a transportation route corresponding to the second transportation request. As illustrated, the second transportation request follows a second transportation route 208 from the second pickup location 202a to the second destination location 202b.

As shown in FIG. 2A, including the second transportation request in a shared transportation with the first transportation request causes the transportation matching system 102 to determine the shared transportation route 204 that may be different than either the first transportation route 206 or the second transportation route alone 208. Specifically, the second pickup location 202a and the second destination location 202b are located between the first pickup location 200a and the first destination location 200b. Thus, the transportation matching system 102 can determine a shared transportation route 204 for the shared transportation by determining a route that begins at the first pickup location 200a, passes through the second pickup location 202a, followed by the second destination location 202b, and terminates at the first destination location 200b.

The transportation matching system 102 can also determine a combined service metric that corresponds to completed transportation services. In one or more embodiments, the transportation matching system 102 determines the combined service metric after the provider has fulfilled the shared transportation. For example, the combined service metric can represent the amount of time taken to fulfill the shared transportation, which includes the total disutility (i.e., the total detour time) experienced by all requesters. Thus, the transportation matching system 102 can determine the total amount of time that a transportation provider used to pick up and drop off every requester associated with a shared transportation after the provider has completed the shared transportation.

After determining the estimated service metrics for the individual transportation requests and the combined service metric for the shared transportation, the transportation matching system 102 can use the estimated service metrics to determine an effect of the transportation requests on the combined service metric. Specifically, the transportation matching system 102 can compare the estimated service metrics for the subsets of transportation requests to the completed service metric. For instance, the transportation matching system 102 can determine how much of the measured value (e.g., travel time) of the combined service metric is attributable to each transportation request.

In one or more embodiments, the transportation matching system 102 determines the effect of transportation requests on a combined service metric by calculating Shapley values for subsets of the transportation requests. In particular, the transportation matching system 102 identifies a plurality of combinations of transportation requests from a shared transportation. To illustrate, in the embodiment of FIG. 2A, the combinations include a first combination with only the first transportation request, a second combination with only the second transportation request, and a third combination including the first transportation request and the second transportation request.

After determining the combinations, the transportation matching system uses the estimated service metrics to determine the Shapley values for the various combinations. Specifically, the transportation matching system 102 determines the Shapley values by averaging the changes in characteristics of each transportation request relative to the combined service metric. For instance, the transportation matching system 102 can determine the difference between the estimated service metric for the first transportation request and the combined service metric. The transportation matching system 102 can also determine the difference between the estimated service metric for the second transportation request and the combined service metric. Using the determined differences, the transportation matching system 102 can then average the differences for each transportation request (e.g., for each requester) to determine the Shapley values for the shared transportation.

The transportation matching system 102 can then determine disutility metrics for the transportation requests using the Shapley values. In one or more embodiments, the disutility metrics can include a cost difference attributed to each requester based on the effects of the transportation requests on the shared transportation. For example, the transportation matching system 102 can determine a disutility metric for the first transportation request by converting the Shapley value for the first transportation request into a cost value (e.g., based on a predetermined monetary value per minute of time difference). The transportation matching system 102 can similarly determine a disutility metric for the second transportation request. Because the disutility metrics represent an effect of the individual transportation requests on the shared transportation, the sum of the disutility metrics equals zero across all transportation requests.

In one or more additional embodiments, the transportation matching system 102 generates a plurality of Shapley values for a shared transportation. Specifically, the transportation matching system 102 can determine a plurality of different estimated service metrics for transportation requests. To illustrate, the transportation matching system 102 can determine separate estimated service metrics representing time, distance, or costs associated with a combination of one or more transportation requests. The transportation matching system 102 can thus generate a plurality of separate Shapley values for a transportation request based on the different estimated service metrics to represent the effects of the transportation requests on the total shared transportation.

Although FIG. 2A illustrates a shared transportation involving two different transportation requests from two requester client devices, the transportation matching system 102 can include more transportation requests in a shared transportation. For example, FIG. 2B illustrates a shared transportation including three transportation requests from three requester client devices. More specifically, the shared transportation includes the first transportation request and the second transportation request of FIG. 2A, as well as a third transportation request.

As shown, the transportation matching system 102 can add an additional transportation request to the shared transportation of FIG. 2A. For instance, the transportation matching system 102 can add the third transportation request to the shared transportation in response to receiving the request from a third requester client device. To illustrate, the transportation matching system 102 can match the third transportation request to the provider client device at the same time as the first transportation request and/or the second transportation request. Alternatively, the transportation matching system 102 can match the third transportation request to the provider client device after the provider has begun fulfilling the transportation request(s) for the first and/or second transportation requests. The transportation matching system 102 can thus determine a route for the shared transportation including the first transportation request, the second transportation request, and the third transportation request.

In one or more embodiments, the transportation matching system 102 determines a shared transportation route 210 for the shared transportation based on the pickup locations and destination locations of the transportation requests. Accordingly, the shared transportation route for the shared transportation of FIG. 2B includes the pickup and destination locations of FIG. 2A in addition to a third pickup location 212a and a third destination location 212b for the third transportation request. As illustrated, the third pickup location 212a and the third destination location 212b for the third transportation request are between the pickup locations and destination locations of the first transportation request and the second transportation request. While FIG. 2B illustrates a specific configuration/order of pickup locations and destination locations of a plurality of transportation requests, a shared transportation can include any configuration of pickup locations and destination locations with overlapping transportation requests in shared transportations.

As mentioned previously, the transportation matching system 102 can determine estimated service metrics for combinations of one or more transportation requests in the shared transportation. Specifically, the transportation matching system 102 can identify possible combinations of the first transportation request, the second transportation request, and the third transportation request (e.g., first, second, third, first-second, first-third, second-third, and first-second-third). To illustrate, the total number of possible combinations involving three separate requests is seven. Accordingly, the transportation matching system 102 can determine estimated service metrics for the different combinations involving the first transportation request, the second transportation request, and the third transportation request.

As shown, the shared transportation route 210 involving the third transportation request, as in FIG. 2B, is different than the shared transportation route 204 excluding the third transportation request, as in FIG. 2A. By including the third transportation request in the shared transportation, one or more of the other requesters may experience additional disutility. For instance, as shown in FIG. 2B, the third pickup location 212a and the third destination location 212b of the third transportation request cause the transportation matching system 102 to divert the shared transportation route. In particular, the shared transportation route 210 of FIG. 2B results in a greater distance traveled and a greater amount of time than either the first transportation request or the second transportation request alone or together.

Accordingly, the transportation matching system 102 can determine the disutility metrics for the transportation requests in the shared transportation based on the effect of the transportation requests on the combined service metric for the shared transportation. The disutility metrics can thus reflect the effects of the transportation requests on the combined service metric by analyzing the estimated service metrics for the combinations of transportation requests and then determining Shapley values for the transportation requests. Specifically, the transportation matching system 102 can determine that the third transportation request (e.g., based on a third transportation route 214) increases the combined service metric in combinations with the first transportation request and/or the second transportation request. Additionally, the transportation matching system 102 can determine that the second transportation request increases the combined service metric in combination with the first transportation request but not in combination with the third transportation request. Finally, the transportation matching system 102 can determine that the first transportation request does not affect the combined service metric in any of the identified combinations.

As one may appreciate, other configurations of transportation requests in shared transportations (e.g., different orders of pickup locations and destination locations for the transportation requests) can result in different determinations of disutility for the transportation requests. For instance, if the third transportation request included a destination after the first destination location or the third destination location, the transportation matching system 102 may determine that the first transportation request and/or the second transportation matching request affects the combined service metric. The transportation matching system 102 can thus determine the disutility for each transportation request in shared transportations and then use the disutility metrics to modify one or more characteristics (e.g., cost) of one or more transportation requests.

Furthermore, the transportation matching system 102 can use transportation data to train a machine-learning model for use in future shared transportations. To illustrate, the transportation matching system 102 can use estimated service metrics, combined service metrics, Shapley values, and disutility metrics to train a machine-learning model to predict metrics for future transportations. Additionally, the transportation matching system 102 can use other information about past transportations such as traffic data, location data (e.g., pickup/destination data), time of day data, provider data, weather data, special events near an area, or other data that the transportation matching system 102 generates or obtains in connection with shared transportations. The transportation matching system 102 can then train a machine-learning model to output a predicted disutility metric or a predicted combined service metric for a transportation request of a shared transportation that is not completed. This may allow the transportation matching system 102 to provide an estimated cost or other value to a requester prior to completion of a shared transportation involving the requester.

As used herein, the term “machine-learning model” refers to a computer representation that can be tuned (e.g., trained) based on inputs to approximate unknown functions. In particular, the term “machine-learning model” can include a model that utilizes algorithms to learn from, and make predictions on, known data by analyzing the known data to learn to generate outputs that reflect patterns and attributes of the known data. For instance, a machine-learning model can include but is not limited to, decision trees, support vector machines, linear regression, logistic regression, Bayesian networks, random forest learning, dimensionality reduction algorithms, boosting algorithms, artificial neural networks (e.g., convolutional neural networks or recurrent neural networks), deep learning, etc. Thus, a machine-learning model makes high-level abstractions in data by generating data-driven predictions or decisions from the known input data. In one or more examples, a machine-learning model can include, or be included in, an object detection network, a scene graph generation model, a cascaded refinement network, and a dynamic memory network. Accordingly, machine-learning models described herein can perform a variety of processes involving image analysis, semantic analysis, or image generation.

In one or more embodiments, the transportation matching system 102 uses transportation data from past shared transportations to calculate expected transportation data for future shared transportations. For example, the transportation matching system 102 can use historical disutility metrics from past transportation requests to predict a disutility metric for a future transportation request involved in a shared transportation. The transportation matching system 102 can use the predicted disutility metric for the future transportation request to generate an expected cost to the requester of the future transportation request. Thus, the transportation matching system 102 can provide a message to the requester client device of the requester corresponding to the future transportation request indicating the expected cost to the requester.

In addition to predicting expected transportation data (e.g., disutility, costs) associated with a shared transportation prior to completion of the shared transportation, the transportation matching system 102 can also use actual transportation data (i.e., calculated after completion of the corresponding shared transportations) to adjust the expected transportation data. For instance, the transportation matching system 102 can use a calculated disutility for a transportation request in a shared transportation to adjust the expected disutility calculated prior to completion of the shared transportation. This can allow the transportation matching system 102, for example, to provide an adjusted/customized transportation fare to the requester of the transportation request if the actual disutility was lower than the expected disutility (e.g., by applying a credit to a user account of the requester or a refund to the requester). Additionally, the transportation matching system 102 can use the difference between the expected disutility and the actual disutility to further train a machine-learning model to improve future predictions of disutility. The transportation matching system 102 can similarly use actual transportation data to modify other predictions of transportation data.

Additionally, the transportation matching system 102 can determine Shapley values associated with estimated service metrics of transportation requests in a shared transportation to determine a service allocation metric associated with the shared transportation. For instance, the transportation matching system 102 can determine a plurality of estimated service metrics corresponding to the combinations of transportation requests in the shared transportation. To illustrate, the service allocation metric for a transportation request can indicate a cost to each transportation request (e.g., to each requester) according to the request's contribution to the total cost of the shared transportation. More specifically, the transportation matching system 102 can use Shapley values associated with the transportation requests (the same Shapley values or different Shapley values from those used to determine disutility) to determine the service allocation metrics for the transportation request. The transportation matching system 102 can also use service allocation metrics to determine the combined service metric (e.g., by using service allocation metrics of historical shared transportations to determine combined service metrics of subsequent shared transportations).

As described above, the transportation matching system 102 can determine Shapley values for a plurality of transportation requests in a shared transportation. In the embodiments described below, the transportation matching system 102 determines the disutility of detours imposed by requesters of a shared transportation on other requesters of the shared transportation. Specifically, the transportation matching system 102 can use the disutility metrics to set or modify shared transportation metrics (e.g., costs) based on the contribution of efficiency gains/losses of each request on a shared transportation. This allows the transportation matching system 102 to account for detour disutility in pricing/costs to each requester and even request matching decisions.

In particular, determining Shapley values can involve computing a cost (or other service metric) associated with serving every possible subset or combination of requesters (e.g., passengers) in the shared transportation. For example, for a route including three separate transportation requests, the transportation matching system 102 thus determines service metrics for each combination of the routes for the transportation requests and for the combination of all transportation requests. The transportation matching system 102 determines the Shapley value for the combinations of the transportation requests by averaging changes in route metrics (e.g., marginal costs) when adding a given request to routes with different subsets of requests. For instance, the transportation matching system 102 can treat the shared transportation as a coalition game. Assuming all players in a set of “players” in the coalition game collaborate, Shapley values distribute their total gains/losses. In other words, Shapley values distribute the cooperative surplus generated by the coalition according to each player's marginal contribution to achieving that surplus.

By utilizing Shapley values to determine the effect of each transportation request on a combined service metric for a shared transportation, the transportation matching system 102 determines a mapping from the set of all transportation requests to payoff vectors that satisfy the efficiency, symmetry, linearity, and “zero player” properties. Specifically, the Shapley values satisfy efficiency by distributing the total surplus generated by cooperation. In the context of shared transportations, this can ensure that metrics (e.g., cost) attributed to each request sums to the combined metric for the route (e.g., the cost paid to the provider).

In one or more embodiments, with respect to symmetry, two players are identical if their gains are equal across all combinations. If the players are identical, then their Shapley values are also identical. Accordingly, the transportation matching system 102 can determine that if two requesters served in a shared transportation have identical transportation requests, they will have the same service metrics and Shapley values.

According to one or more embodiments, with respect to linearity, if two coalition games are combined, the distributed gains/losses from the combined game to a first player corresponds to the gains/losses from the first coalition game and the gains/losses from the second coalition game, such that the Shapley values for the combination of the coalition games is equal to the sum of Shapley values for each coalition game. This additivity characteristic of Shapley values allows the transportation matching system 102 to combine Shapley provider and disutility values of requests into yet other Shapley values. Furthermore, the transportation matching system 102 provide homogeneity in the disutility metrics such that for any real number, the transportation matching system 102 has Shapley values in a coalition game that are equal to the Shapley values multiplied by the real number. The transportation matching system 102 can leverage the homogeneity to estimate the Shapley value for a transportation request ahead of time and determine an estimate of the total combined service metric. By realizing an actual combined service metric for a shared transportation, the transportation matching system 102 can determine “corrected” Shapley values by rescaling the Shapley values according to the actual combined service metric.

In terms of shared transportations, if adding a particular transportation request to a shared transportation is costless, regardless of other requests that are already part of the shared transportation, the allocated cost (or other metric) for the transportation request is 0. Specifically, the Shapley values, including the disutility metric, for the transportation request is 0, as the transportation request does not cause any other transportation requests in the shared transportation to experience a loss.

Additionally, in one or more embodiments, the transportation matching system 102 uses a request-specific match efficiency that determines separate match efficiencies (e.g., how accurately the transportation matching system 102 matched the transportation request to a provider client device) for transportation requests in the same shared transportation. In particular, the transportation matching system 102 can modify a match efficiency for a shared transportation where the cost allocation for each transportation request is a Shapley-based driver cost allocation, as mentioned previously. The costs attributed to a request are based on that request's unmatched cost as a proportion of the total unmatched cost of the shared transportation. The transportation matching system can also apply disutility metrics to the match efficiency of individual transportation requests.

In one or more embodiments, the transportation matching system 102 determines disutility allocations for transportation requests in a shared transportation. In particular, the transportation matching system 102 can determine a disutility metric (or disutility score) for a given transportation request in a shared transportation is based on the trip time of the given transportation request within the shared transportation. The transportation matching system 102 can capture utility/preferences of requesters and then use the utility/preferences of the requesters in matching transportation requests to provider client devices in connection with shared transportations.

Additionally, the transportation matching system 102 can allocate the total realized disutility via Shapley's method. From the total detour Shapley allocation of a given transportation request in the shared transportation, the transportation matching system 102 subtracts the detour actually experienced to arrive at the detour externality imposed by the given transportation request on other requests. If the disutility metric for the given transportation request has a positive value, the given transportation request impacted other requests more than the other requests impacted the given transportation request. Conversely, if the disutility metric is negative, the transportation request impacted the other requests less than the other requests impacted the given transportation requests.

Instead of presuming that a transportation route is only as good as the average detour experienced by the requests in a shared transportation, the transportation matching system 102 alternatively determines that a transportation route is only as good as the worst detour experienced by its requests. Specifically, the transportation matching system 102 can use a Rawlsian perspective for determining the value of the transportation route.

Furthermore, as mentioned previously, the sum of disutility metrics across all transportation requests in a shared transportation is 0, as the disutility represents the effect of each request on other requests. Additionally, the disutility metric is also a Shapley value.

In one or more embodiments, the transportation matching system 102 determines the disutility metrics in units of time representing the time disutility. Alternatively, the transportation matching system 102 can use other types of metrics other than time, as mentioned previously. Furthermore, the transportation matching system 102 can convert the disutility metrics to a cost value, such as by assuming that each unit of disutility metric corresponds to a predetermined cost value (e.g., dollar per time unit). The transportation matching system 102 can add disutility values (e.g., in cost terms) to allocated provider service metrics (e.g., costs) to arrive at quality adjusted service metric decomposition. To illustrate, if the transportation matching system 102 determines that a particular request has a negative disutility, the transportation matching system 102 can apply an additional discount to a corresponding requester's shared transportation cost.

As previously mentioned, the transportation matching system 102 can also determine the allocated provider service metrics based on Shapley values. For instance, the transportation matching system 102 can determine an allocated cost (to the provider) of serving each combination of transportation requests in a shared transportation based on Shapley values for the combinations of transportation requests. To determine the allocated costs, in one or more embodiments, the transportation matching system 102 utilizes a route identifier, a shared transportation identifier, a provider client device identifier, and an ordering of the requests within the shared transportation. Additionally, for each request, the transportation matching system 102 can use a route identifier, a shared transportation identifier, a type of transportation (e.g., one of several types of shared transportations), request location, acceptance location, arrival location, pickup location, destination location, cost minimum for provider (i.e., if the requester is the first pickup), cost per mile/distance unit for provider, cost per minute/time unit for provider, and pickup charge for provider.

Furthermore, in one or more embodiments, the transportation matching system 102 determines predicted distance and time for each possible segment (i,j) ∈{PickupLocations ∪DropoffLocations}². The transportation matching system 102 can structure these predictions into distance and time adjacency matrices, respectively. For example, if there are N requests served in a shared transportation, the transportation matching system 102 determines (2N) (2N−1) segment predictions for distance and time, respectively. Additionally, the transportation matching system 102 may use historical predictions by accounting for variations in traffic conditions when estimating the cost of serving hypothetical sub-coalitions of requests. The transportation matching system 102 can determine the predictions in real time at the end of the shared transportation. Alternatively, the transportation matching system 102 can generate predictions at every provider acceptance and/or request cancellation event, and then use the most recent prediction as a final version.

Also as described previously, the transportation matching system 102 can use these allocated service metrics in determining combined service metrics for shared transportations. To illustrate, the transportation matching system 102 can use historical data associated with previous shared transportations to set one or more values used in determining the combined service metrics (e.g., cost per unit of time/distance). Additionally, the transportation matching system 102 can use the allocated service metrics for training one or more machine-learning models to predict metrics for subsequent shared transportations.

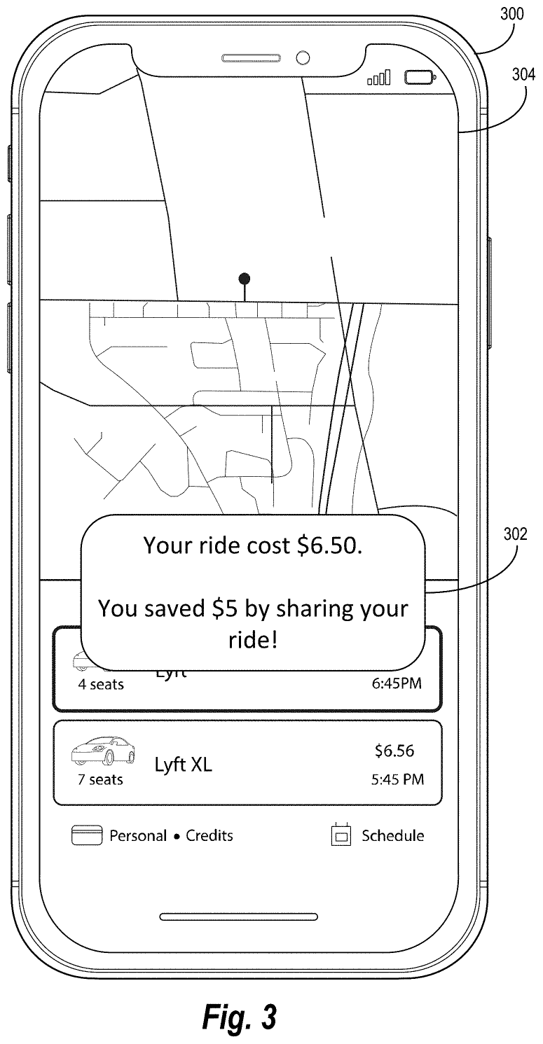

As mentioned, the transportation matching system 102 can generate a message with information associated with a disutility metric to display at a requester client device. FIG. 3 illustrates an embodiment of a requester client device 300 including a client application that allows a requester to request transportation from a provider. Specifically, FIG. 3 illustrates displaying a message including information about a shared transportation based on disutility determined for a requester.

In one or more embodiments, the transportation matching system 102 generates a message for a shared transportation based on a disutility metric that the transportation matching system 102 determined for a transportation request corresponding to the requester client device 300. In particular, the transportation matching system 102 can generate an electronic message 302 to send to the requester client device 300, causing the requester client device 300 to display the electronic message 302 within a client application 304 associated with the transportation matching system 102. For instance, the client application 304 can display the electronic message 302 as an overlay on top of the client application (e.g., on top of a map interface) or within another area of the client application 304. Alternatively, the transportation matching system 102 can cause the requester client device 300 to display the electronic message 302 as a notification (e.g., at an operating system level).

According to one or more embodiments, the transportation matching system 102 generates the electronic message 302 to include an indication of the disutility metric. For example, the electronic message 302 can include a message with the metric (or a value based on the metric). To illustrate, if the transportation matching system 102 generates the disutility metric as a time value based on the difference in time experienced by the user based on detours caused by other requests in a shared transportation, the electronic message 302 can include a metric based on the time value such as a cost. As shown in FIG. 3, the electronic message 302 can include a cost of a shared transportation to a requester and an indicator of an amount saved by taking the shared transportation instead of the requester's transportation request alone. Furthermore, because the disutility metrics for transportation requests in a shared transportation can be different, the transportation matching system 102 can generate different messages (e.g., with different shared transportation costs) to display to requesters associated with the different transportation requests.

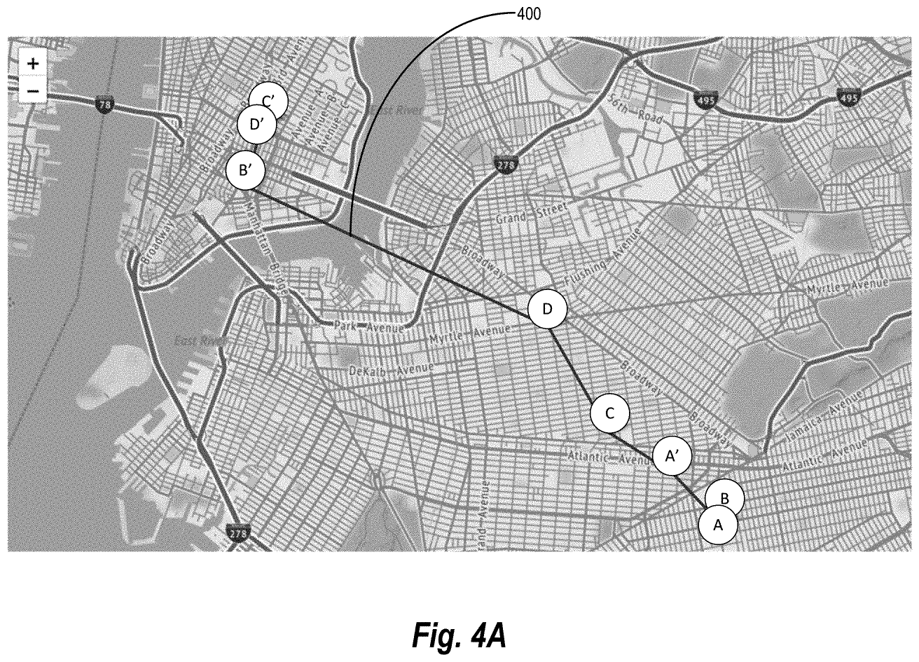

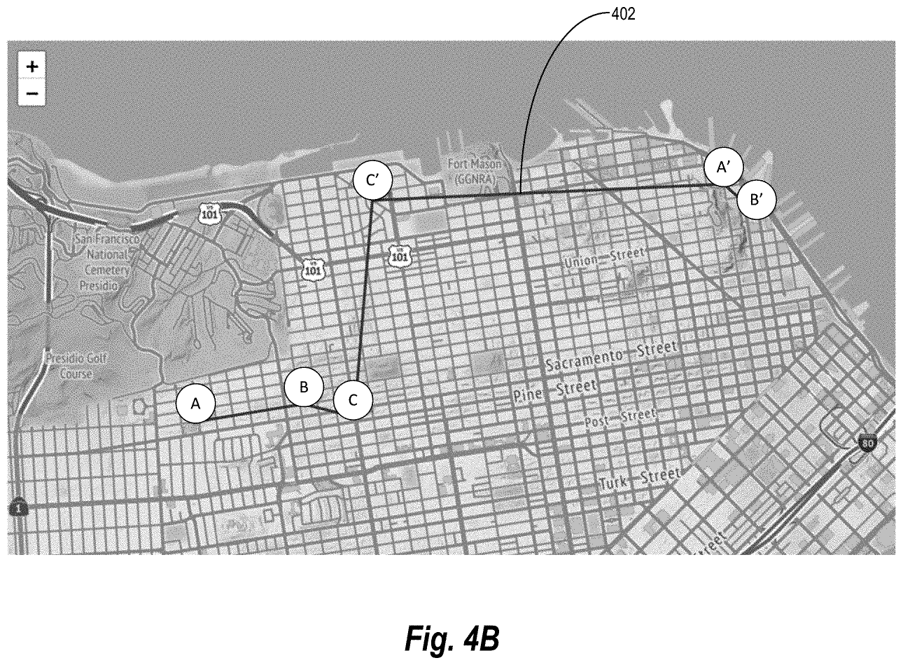

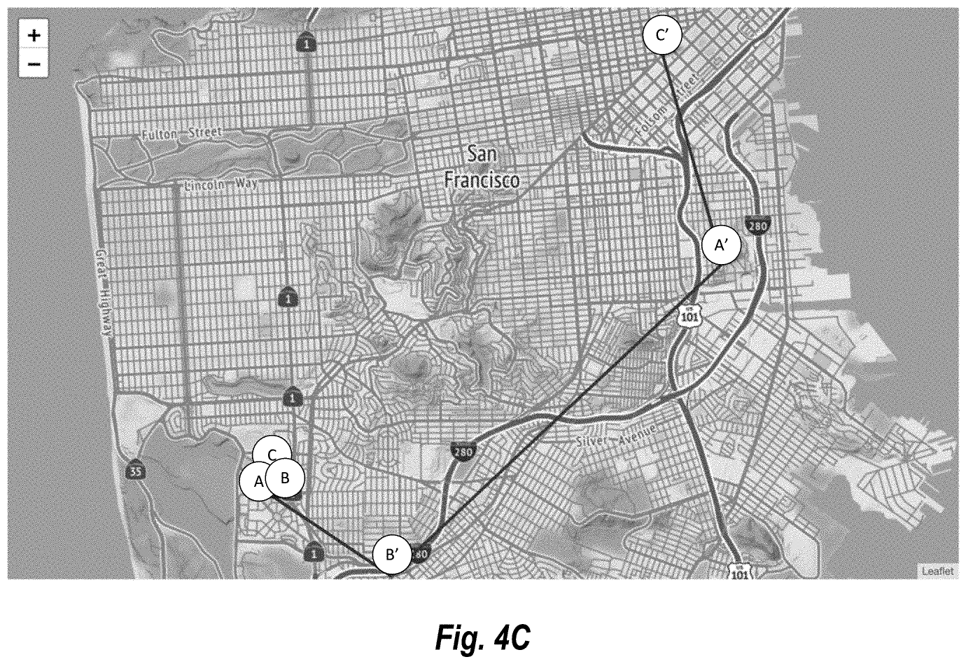

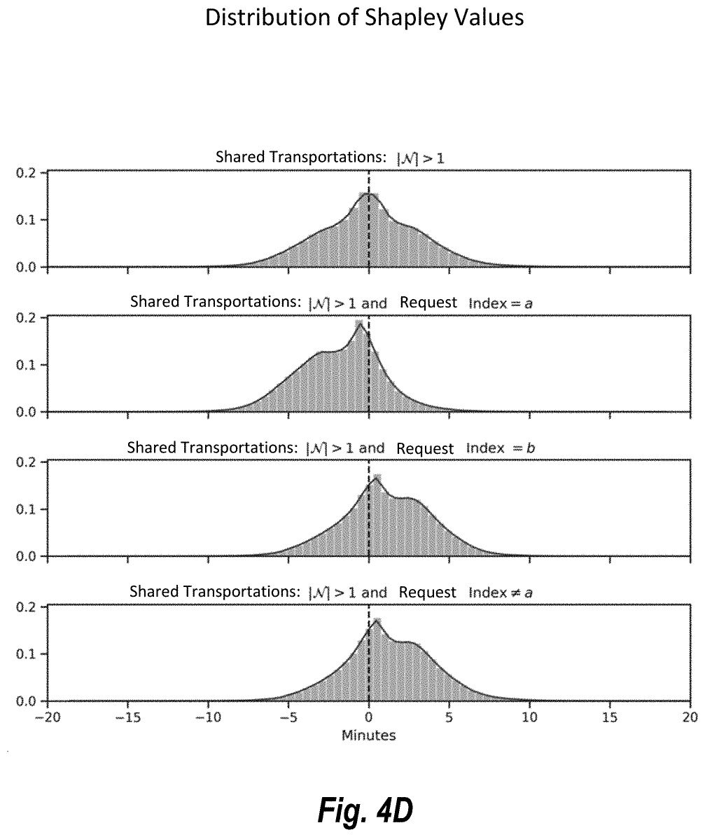

FIGS. 4A-4C illustrate example embodiments and data associated with shared transportations involving a plurality of transportation requests. In particular, FIGS. 4A-4C illustrate map embodiments of shared transportation routes for a plurality of completed transportation requests. Each shared transportation route in FIGS. 4A-4C includes different combinations of transportation requests from a plurality of different requester client devices.

As mentioned, the transportation matching system 102 can generate one or more Shapley values for a shared transportation such as for cost allocations and/or disutility metrics. In the embodiment of FIG. 4A, the transportation matching system 102 determined transportation data for a first transportation route 400. Specifically, the shared transportation of FIG. 4A includes a first transportation request with a pickup location at A and a destination location at A′, a second transportation request with a pickup location at B and a destination location at B′, a third transportation request with a pickup location at C and a destination location at C′, and a fourth transportation request with a pickup location at D and a destination location at D′.

The transportation matching system 102 determined that a Shapley-based match efficiency (e.g., based on the Shapley cost to the provider) of the first transportation request is 0.209418, a match efficiency of the second transportation request is 0.518068, a match efficiency of the third transportation request is 0.503758, and a match efficiency of the fourth transportation request is 0.506698. The differences in match efficiency for the transportation requests reflect the differences in costs that the transportation requests impose on the provider for the shared transportation.

The transportation matching system 102 can determine an order of transportation requests in a shared transportation. The transportation matching system 102 can also determine other details associated with the shared transportation including times of acceptance and pickup, costs to the provider based on the pickup/destination locations of the requests, proportional (transportation-level) match efficiency that corresponds to the shared transportation as a whole, and Shapley-based match efficiency that indicates the match efficiency for each individual transportation request. Because each request has a different pickup location and destination location, the costs reflect the different costs to the provider associated with each transportation request (e.g., indicating that a first request has the lowest allocated cost). Furthermore, while the proportional match efficiency is the same for each request, the Shapley match efficiencies are different.

FIG. 4B illustrates a second transportation route 402 with a plurality of transportation requests. In addition to determining costs to the provider and match efficiencies for the transportation requests in a shared transportation, the transportation matching system 102 can determine disutility values for the transportation requests. For example, the transportation matching system 102 determined that the disutility metric for a first transportation request (A, A′) is −1.708423, the disutility metric for a second transportation request (B, B′) is −1.976549, and the disutility metric for a third transportation request (C, C′) is 3.684973. As shown, the transportation matching system can determine from the disutility metrics that the first transportation request and the second transportation request have negative disutility, indicating that the first and second transportation requests inconvenience/modify other transportation requests less than other transportation requests inconvenience/modify the first and second transportation requests. Conversely, the third transportation request has a positive disutility metric, indicating that the third transportation request inconveniences other transportation requests more than other transportation requests inconvenience/modify the third transportation request. Furthermore, as shown, the disutility metrics sum to zero.

Similar to the embodiment of FIG. 4B, the transportation matching system 102 determines Shapley values for disutility metrics for a shared transportation in FIG. 4C. As shown, the transportation matching system 102 can determine from the Shapley values representing disutility metrics that a first transportation metric (A, A′) and a third transportation request (C, C′) have positive disutility metrics, while a second transportation request (B, B′) has a negative disutility score. Accordingly, the transportation matching system 102 can determine that the second transportation request has a lesser negative impact (disutility metric of −1.791812) on the other transportation requests than the first and third transportation requests have on the second transportation request (disutility metrics of 0.186260 and 1.605551, respectively). In one or more embodiments, the transportation matching system 102 can thus use the resulting disutility metrics to determine transportation fares for the individual requests. To illustrate, if the disutility metrics represent minutes or other time units, the transportation matching system 102 can apply a predetermined conversion value (e.g., $0.10, $0.50, or any monetary value) to the disutility metrics to determine dollar values to add or subtract from shared transportation fares to the respective transportation requests.

Turning now to FIG. 5, this figure shows a flowchart of a series of acts 500 of determining disutility of shared transportations involving a plurality of transportation requests. While FIG. 5 illustrates acts according to one embodiment, alternative embodiments may omit, add to, reorder, and/or modify any of the acts shown in FIG. 5. The acts of FIG. 5 can be performed as part of a method. Alternatively, a non-transitory computer readable storage medium can comprise instructions that, when executed by one or more processors, cause a computing device to perform the acts depicted in FIG. 5. In still further embodiments, a system can perform the acts of FIG. 5.

As shown, the series of acts 500 includes an act 502 of identifying a shared transportation for a combination of transportation requests. For example, act 502 involves identifying, by a transportation matching system, a shared transportation for a combination of transportation requests comprising at least a first transportation request associated with a first requester device and a second transportation request associated with a second requester device.

The series of acts 500 also includes an act 504 of determining estimated service metrics corresponding to subsets of the transportation requests. For example, act 504 involves determining, by the transportation matching system, estimated service metrics corresponding to subsets of the transportation requests of the shared transportation. Act 504 can involve determining, for a given subset of the transportation requests, an amount of time associated with traveling to pickup locations and destination locations associated with the subset of the transportation requests. Additionally, act 504 can involve determining, for a given subset of the transportation requests a distance associated with traveling to pickup locations and destination locations associated with the subset of the transportation requests.

Additionally, the series of acts 500 include an act 506 of calculating a disutility metric for each transportation request. For example, act 506 involves calculating, based on the estimated service metrics, a disutility metric for each transportation request of the transportation requests of the shared transportation. Act 506 can involve calculating a detour attributable to the first transportation request based on estimated service metrics corresponding to subsets of the transportation requests comprising the first transportation request. Additionally, act 506 can involve calculating the detour attributable to the first transportation request relative to a detour attributable to other transportation requests of the shared transportation, wherein the detour of attributable to the first transportation request and the detour attributable to the other transportation requests sum to zero.

Furthermore, the series of acts 500 include an act 508 of providing a message associated with the calculated disutility metric. For example, act 508 involves providing, for display by the first requester device and based on a calculated disutility metric for the first transportation request, a message associated with the calculated disutility metric for the first transportation request. Act 508 can involve generating an electronic message that indicates a cost to a first requester associated with the first requester device based on the disutility metric.

The series of acts 500 can also include generating, using a machine-learning model for predicting disutility metrics and based on the estimated service metrics, a predicted disutility metric for the first transportation request of the shared transportation prior to completion of the shared transportation. Additionally, the series of acts 500 can include determining a difference between the predicted disutility metric for the first transportation request and the calculated disutility metric for the first transportation request. As part of act 508, the series of acts 500 can also include customizing the message based on the difference between the predicted disutility metric and the calculated disutility metric.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system, including by one or more servers. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, virtual reality devices, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 6 illustrates, in block diagram form, an exemplary computing device 600 that may be configured to perform one or more of the processes described above. One will appreciate that the transportation matching system 102 can comprise implementations of the computing device 600, including, but not limited to, the server(s) 104, the provider client devices 110a-110n, and the requester client devices 106a-106n. As shown by FIG. 6, the computing device can comprise a processor 602, memory 604, a storage device 606, an I/O interface 608, and a communication interface 610. In certain embodiments, the computing device 600 can include fewer or more components than those shown in FIG. 6. Components of computing device 600 shown in FIG. 6 will now be described in additional detail.

In particular embodiments, processor(s) 602 includes hardware for executing instructions, such as those making up a computer program. As an example, and not by way of limitation, to execute instructions, processor(s) 602 may retrieve (or fetch) the instructions from an internal register, an internal cache, memory 604, or a storage device 606 and decode and execute them.

The computing device 600 includes memory 604, which is coupled to the processor(s) 602. The memory 604 may be used for storing data, metadata, and programs for execution by the processor(s). The memory 604 may include one or more of volatile and non-volatile memories, such as Random Access Memory (“RAM”), Read Only Memory (“ROM”), a solid-state disk (“SSD”), Flash, Phase Change Memory (“PCM”), or other types of data storage. The memory 604 may be internal or distributed memory.

The computing device 600 includes a storage device 606 includes storage for storing data or instructions. As an example, and not by way of limitation, storage device 606 can comprise a non-transitory storage medium described above. The storage device 606 may include a hard disk drive (“HDD”), flash memory, a Universal Serial Bus (“USB”) drive or a combination of these or other storage devices.

The computing device 600 also includes one or more input or output (“I/O”) interface 608, which are provided to allow a user (e.g., requester or provider) to provide input to (such as user strokes), receive output from, and otherwise transfer data to and from the computing device 600. These I/O interface 608 may include a mouse, keypad or a keyboard, a touch screen, camera, optical scanner, network interface, modem, other known I/O devices or a combination of such I/O interface 608. The touch screen may be activated with a stylus or a finger.

The I/O interface 608 may include one or more devices for presenting output to a user, including, but not limited to, a graphics engine, a display (e.g., a display screen), one or more output providers (e.g., display providers), one or more audio speakers, and one or more audio providers. In certain embodiments, interface 608 is configured to provide graphical data to a display for presentation to a user. The graphical data may be representative of one or more graphical user interfaces and/or any other graphical content as may serve a particular implementation.

The computing device 600 can further include a communication interface 610. The communication interface 610 can include hardware, software, or both. The communication interface 610 can provide one or more interfaces for communication (such as, for example, packet-based communication) between the computing device and one or more other computing devices 600 or one or more networks. As an example, and not by way of limitation, communication interface 610 may include a network interface controller (“NIC”) or network adapter for communicating with an Ethernet or other wire-based network or a wireless NIC (“WNIC”) or wireless adapter for communicating with a wireless network, such as a WI-FI. The computing device 600 can further include a bus 612. The bus 612 can comprise hardware, software, or both that couples components of computing device 600 to each other.

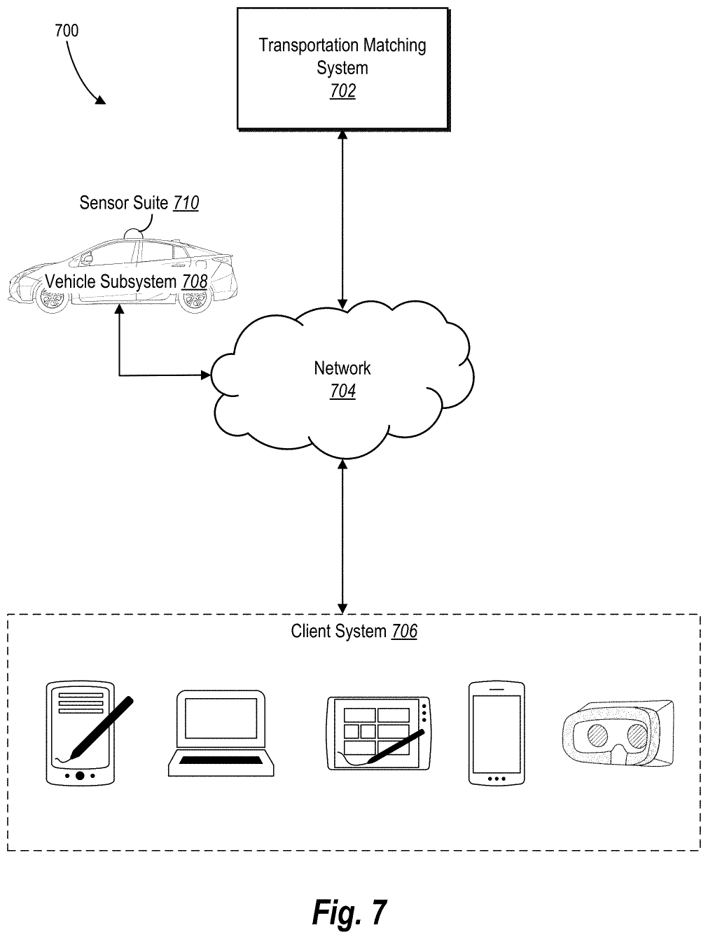

FIG. 7 illustrates an example network environment 700 of a transportation matching system 702. The network environment 700 includes a client device 706, a transportation matching system 702, and a vehicle subsystem 708 connected to each other by a network 704. Although FIG. 7 illustrates a particular arrangement of the client device 706, transportation matching system 702, vehicle subsystem 708, and network 704, this disclosure contemplates any suitable arrangement of client device 706, transportation matching system 702, vehicle subsystem 708, and network 704. As an example, and not by way of limitation, two or more of client device 706, transportation matching system 702, and vehicle subsystem 708 communicate directly, bypassing network 704. As another example, two or more of client device 706, transportation matching system 702, and vehicle subsystem 708 may be physically or logically co-located with each other in whole or in part. Moreover, although FIG. 7 illustrates a particular number of client devices 706, transportation matching systems 702, vehicle subsystems 708, and networks 704, this disclosure contemplates any suitable number of client devices 706, transportation matching systems 702, vehicle subsystems 708, and networks 704. As an example, and not by way of limitation, network environment 700 may include multiple client device 706, transportation matching systems 702, vehicle subsystems 708, and networks 704.

This disclosure contemplates any suitable network 704. As an example, and not by way of limitation, one or more portions of network 704 may include an ad hoc network, an intranet, an extranet, a virtual private network (“VPN”), a local area network (“LAN”), a wireless LAN (“WLAN”), a wide area network (“WAN”), a wireless WAN (“WWAN”), a metropolitan area network (“MAN”), a portion of the Internet, a portion of the Public Switched Telephone Network (“PSTN”), a cellular telephone network, or a combination of two or more of these. Network 704 may include one or more networks 704.

Links may connect client device 706, transportation matching system 702, and vehicle subsystem 708 to network 704 or to each other. This disclosure contemplates any suitable links. In particular embodiments, one or more links include one or more wireline (such as for example Digital Subscriber Line (“DSL”) or Data Over Cable Service Interface Specification (“DOCSIS”), wireless (such as for example Wi-Fi or Worldwide Interoperability for Microwave Access (“WiMAX”), or optical (such as for example Synchronous Optical Network (“SONET”) or Synchronous Digital Hierarchy (“SDH”) links. In particular embodiments, one or more links each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link, or a combination of two or more such links. Links need not necessarily be the same throughout network environment 700. One or more first links may differ in one or more respects from one or more second links.

In particular embodiments, client device 706 may be an electronic device including hardware, software, or embedded logic components or a combination of two or more such components and capable of carrying out the appropriate functionalities implemented or supported by client device 706. As an example, and not by way of limitation, a client device 706 may include any of the computing devices discussed above in relation to FIG. 6. A client device 706 may enable a network user at client device 706 to access network 704. A client device 706 may enable its user to communicate with other users at other client devices 706.

In particular embodiments, client device 706 may include a requester application or a web browser, such as MICROSOFT INTERNET EXPLORER, GOOGLE CHROME or MOZILLA FIREFOX, and may have one or more add-ons, plug-ins, or other extensions, such as TOOLBAR or YAHOO TOOLBAR. A user at client device 706 may enter a Uniform Resource Locator (“URL”) or other address directing the web browser to a particular server (such as server), and the web browser may generate a Hyper Text Transfer Protocol (“HTTP”) request and communicate the HTTP request to server. The server may accept the HTTP request and communicate to client device 706 one or more Hyper Text Markup Language (“HTML”) files responsive to the HTTP request. Client device 706 may render a webpage based on the HTML files from the server for presentation to the user. This disclosure contemplates any suitable webpage files. As an example, and not by way of limitation, webpages may render from HTML files, Extensible Hyper Text Markup Language (“XHTML”) files, or Extensible Markup Language (“XML”) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a webpage encompasses one or more corresponding webpage files (which a browser may use to render the webpage) and vice versa, where appropriate.

In particular embodiments, transportation matching system 702 may be a network-addressable computing system that can host a transportation matching network. Transportation matching system 702 may generate, store, receive, and send data, such as, for example, user-profile data, concept-profile data, text data, transportation request data, GPS location data, provider data, requester data, vehicle data, or other suitable data related to the transportation matching network. This may include authenticating the identity of providers and/or vehicles who are authorized to provide transportation services through the transportation matching system 702. In addition, the transportation matching system may manage identities of service requesters such as users/requesters. In particular, the transportation matching system 702 may maintain requester data such as driving/riding histories, personal data, or other user data in addition to navigation and/or traffic management services or other location services (e.g., GPS services).

In particular embodiments, the transportation matching system 702 may manage transportation matching services to connect a user/requester with a vehicle and/or provider. By managing the transportation matching services, the transportation matching system 702 can manage the distribution and allocation of resources from the vehicle subsystem 708 and user resources such as GPS location and availability indicators, as described herein.

Transportation matching system 702 may be accessed by the other components of network environment 700 either directly or via network 704. In particular embodiments, transportation matching system 702 may include one or more servers. Each server may be a unitary server or a distributed server spanning multiple computers or multiple datacenters. Servers may be of various types, such as, for example and without limitation, web server, news server, mail server, message server, advertising server, file server, application server, exchange server, database server, proxy server, another server suitable for performing functions or processes described herein, or any combination thereof. In particular embodiments, each server may include hardware, software, or embedded logic components or a combination of two or more such components for carrying out the appropriate functionalities implemented or supported by server. In particular embodiments, transportation matching system 702 may include one or more data stores. Data stores may be used to store various types of information. In particular embodiments, the information stored in data stores may be organized according to specific data structures. In particular embodiments, each data store may be a relational, columnar, correlation, or other suitable database. Although this disclosure describes or illustrates particular types of databases, this disclosure contemplates any suitable types of databases. Particular embodiments may provide interfaces that enable a client device 706, or a transportation matching system 702 to manage, retrieve, modify, add, or delete, the information stored in data store.

In particular embodiments, transportation matching system 702 may provide users with the ability to take actions on various types of items or objects, supported by transportation matching system 702. As an example, and not by way of limitation, the items and objects may include transportation matching networks to which users of transportation matching system 702 may belong, vehicles that users may request, location designators, computer-based applications that a user may use, transactions that allow users to buy or sell items via the service, interactions with advertisements that a user may perform, or other suitable items or objects. A user may interact with anything that is capable of being represented in transportation matching system 702 or by an external system of a third-party system, which is separate from transportation matching system 702 and coupled to transportation matching system 702 via a network 704.

In particular embodiments, transportation matching system 702 may be capable of linking a variety of entities. As an example, and not by way of limitation, transportation matching system 702 may enable users to interact with each other or other entities, or to allow users to interact with these entities through an application programming interfaces (“API”) or other communication channels.

In particular embodiments, transportation matching system 702 may include a variety of servers, sub-systems, programs, modules, logs, and data stores. In particular embodiments, transportation matching system 702 may include one or more of the following: a web server, action logger, API-request server, relevance-and-ranking engine, content-object classifier, notification controller, action log, third-party-content-object-exposure log, inference module, authorization/privacy server, search module, advertisement-targeting module, user-interface module, user-profile store, connection store, third-party content store, or location store. Transportation matching system 702 may also include suitable components such as network interfaces, security mechanisms, load balancers, failover servers, management-and-network-operations consoles, other suitable components, or any suitable combination thereof. In particular embodiments, transportation matching system 702 may include one or more user-profile stores for storing user profiles. A user profile may include, for example, biographic information, demographic information, behavioral information, social information, or other types of descriptive information, such as work experience, educational history, hobbies or preferences, interests, affinities, or location.

The web server may include a mail server or other messaging functionality for receiving and routing messages between transportation matching system 702 and one or more client devices 706. An action logger may be used to receive communications from a web server about a user's actions on or off transportation matching system 702. In conjunction with the action log, a third-party-content-object log may be maintained of user exposures to third-party-content objects. A notification controller may provide information regarding content objects to a client device 706. Information may be pushed to a client device 706 as notifications, or information may be pulled from client device 706 responsive to a request received from client device 706. Authorization servers may be used to enforce one or more privacy settings of the users of transportation matching system 702. A privacy setting of a user determines how particular information associated with a user can be shared. The authorization server may allow users to opt in to or opt out of having their actions logged by transportation matching system 702 or shared with other systems, such as, for example, by setting appropriate privacy settings. Third-party-content-object stores may be used to store content objects received from third parties. Location stores may be used for storing location information received from client devices 706 associated with users.

In addition, the vehicle subsystem 708 can include a human-operated vehicle or an autonomous vehicle. A provider of a human-operated vehicle can perform maneuvers to pick up, transport, and drop off one or more requesters according to the embodiments described herein. In certain embodiments, the vehicle subsystem 708 can include an autonomous vehicle—i.e., a vehicle that does not require a human operator. In these embodiments, the vehicle subsystem 708 can perform maneuvers, communicate, and otherwise function without the aid of a human provider, in accordance with available technology.

In particular embodiments, the vehicle subsystem 708 may include one or more sensors incorporated therein or associated thereto. For example, sensor(s) 710 can be mounted on the top of the vehicle subsystem 708 or else can be located within the interior of the vehicle subsystem 708. In certain embodiments, the sensor(s) 710 can be located in multiple areas at once—i.e., split up throughout the vehicle subsystem 708 so that different components of the sensor(s) 710 can be placed in different locations in accordance with optimal operation of the sensor(s) 710. In these embodiments, the sensor(s) 710 can include a LIDAR sensor and an inertial measurement unit (“IMU”) including one or more accelerometers, one or more gyroscopes, and one or more magnetometers. The sensor(s) 710 can additionally or alternatively include a wireless IMU (“WIMU”), one or more cameras, one or more microphones, or other sensors or data input devices capable of receiving and/or recording information relating to navigating a route to pick up, transport, and/or drop off a requester.

In particular embodiments, the vehicle subsystem 708 may include a communication device capable of communicating with the client device 706 and/or the transportation matching system 702. For example, the vehicle subsystem 708 can include an on-board computing device communicatively linked to the network 704 to transmit and receive data such as GPS location information, sensor-related information, requester location information, or other relevant information.

In the foregoing specification, the invention has been described with reference to specific exemplary embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the invention is, therefore, indicated by the appended claims rather than by the foregoing description. All changes that come within the meaning and range of equivalency of the claims are to be embraced within their scope.

We claim:

1. A computer-implemented method comprising:
identifying, by a transportation matching system, a shared transportation for a combination of transportation requests comprising at least a first transportation request associated with a first requester device and a second transportation request associated with a second requester device;
determining, by the transportation matching system, estimated service metrics corresponding to subsets of the transportation requests of the shared transportation;
calculating, based on the estimated service metrics, a disutility metric for each transportation request of the transportation requests of the shared transportation; and
providing, for display by the first requester device and based on a calculated disutility metric for the first transportation request, a message associated with the calculated disutility metric for the first transportation request.

2. The computer-implemented method of claim 1, wherein:
calculating the disutility metric comprises calculating the disutility metric after completion of the shared transportation; and
providing the message associated with the calculated disutility metric comprises providing the message after completion of the shared transportation.

3. The computer-implemented method of claim 1, wherein determining the estimated service metrics corresponding to the subsets of transportation requests comprises determining, for a given subset of the transportation requests, an amount of time associated with traveling to pickup locations and destination locations associated with the subset of the transportation requests.

4. The computer-implemented method of claim 1, wherein determining the estimated service metrics corresponding to the subsets of transportation requests comprises determining, for a given subset of the transportation requests a distance associated with traveling to pickup locations and destination locations associated with the given subset of the transportation requests.

5. The computer-implemented method of claim 1, wherein calculating the disutility metric for the first transportation request comprises calculating a detour attributable to the first transportation request based on estimated service metrics corresponding to subsets of the transportation requests comprising the first transportation request.

6. The computer-implemented method of claim 5, wherein calculating the disutility metric for the first transportation request further comprises calculating the detour attributable to the first transportation request relative to a detour attributable to other transportation requests of the shared transportation, wherein the detour attributable to the first transportation request and the detour attributable to the other transportation requests sum to zero.

7. The computer-implemented method of claim 1, further comprising:
generating, using a machine-learning model for predicting disutility metrics and based on the estimated service metrics, a predicted disutility metric for the first transportation request of the shared transportation prior to completion of the shared transportation;
determining a difference between the predicted disutility metric for the first transportation request and the calculated disutility metric for the first transportation request; and
customizing the message based on the difference between the predicted disutility metric and the calculated disutility metric.

8. A system comprising:
at least one processor; and
at least one non-transitory computer readable storage medium comprising instructions that, when executed by the at least one processor, cause the system to:
identify a shared transportation for a combination of transportation requests comprising at least a first transportation request associated with a first requester device and a second transportation request associated with a second requester device;
determine estimated service metrics corresponding to subsets of the transportation requests of the shared transportation;
calculate, based on the estimated service metrics, a disutility metric for each transportation request of the transportation requests of the shared transportation; and
provide, for display by the first requester device and based on a calculated disutility metric for the first transportation request, a message associated with the calculated disutility metric for the first transportation request.

9. The system of claim 8, wherein the instructions that, when executed by the at least one processor, cause the system to:
calculate the disutility metric further cause the system to calculate the disutility metric after completion of the shared transportation; and
provide the message associated with the calculated disutility metric further cause the system to provide the message after completion of the shared transportation.

10. The system of claim 8, wherein the instructions that, when executed by the at least one processor, cause the system to determine the estimated service metrics corresponding to the subsets of transportation requests further cause the system to determine, for a given subset of the transportation requests, an amount of time associated with traveling to pickup locations and destination locations associated with the subset of the transportation requests.

11. The system of claim 8, wherein the instructions that, when executed by the at least one processor, cause the system to determine the estimated service metrics corresponding to the subsets of transportation requests further cause the system to determine, for a given subset of the transportation requests a distance associated with traveling to pickup locations and destination locations associated with the given subset of the transportation requests.

12. The system of claim 8, wherein the instructions that, when executed by the at least one processor, cause the system to calculate the disutility metric for the first transportation request further cause the system to calculate a detour attributable to the first transportation request based on estimated service metrics corresponding to subsets of the transportation requests comprising the first transportation request.

13. The system of claim 12, wherein the instructions that, when executed by the at least one processor, cause the system to calculate the disutility metric for the first transportation request further cause the system to calculate the detour attributable to the first transportation request relative to a detour attributable to other transportation requests of the shared transportation, wherein the detour attributable to the first transportation request and the detour attributable to the other transportation requests sum to zero.

14. The system of claim 8, further comprising instructions that, when executed by the at least one processor, cause the system to:
generate, using a machine-learning model for predicting disutility metrics and based on the estimated service metrics, a predicted disutility metric for the first transportation request of the shared transportation prior to completion of the shared transportation;
determine a difference between the predicted disutility metric for the first transportation request and the calculated disutility metric for the first transportation request; and
customizing the message based on the difference between the predicted disutility metric and the calculated disutility metric.

15. A non-transitory computer readable storage medium comprising instructions that, when executed by at least one processor, cause a computer system to:
identify a shared transportation for a combination of transportation requests comprising at least a first transportation request associated with a first requester device and a second transportation request associated with a second requester device;
determine estimated service metrics corresponding to subsets of the transportation requests of the shared transportation;
calculate, based on the estimated service metrics, a disutility metric for each transportation request of the transportation requests of the shared transportation; and
provide, for display by the first requester device and based on a calculated disutility metric for the first transportation request, a message associated with the calculated disutility metric for the first transportation request.

16. The non-transitory computer readable storage medium of claim 15, wherein the instructions that, when executed by the at least one processor, cause the computer system to:
calculate the disutility metric further cause the computer system to calculate the disutility metric after completion of the shared transportation; and
provide the message associated with the calculated disutility metric further cause the computer system to provide the message after completion of the shared transportation.

17. The non-transitory computer readable storage medium of claim 15, wherein the instructions that, when executed by the at least one processor, cause the computer system to determine the estimated service metrics corresponding to the subsets of transportation requests further cause the computer system to determine, for a given subset of the transportation requests, an amount of time associated with traveling to pickup locations and destination locations associated with the subset of the transportation requests.

18. The non-transitory computer readable storage medium of claim 15, wherein the instructions that, when executed by the at least one processor, cause the computer system to determine the estimated service metrics corresponding to the subsets of transportation requests further cause the computer system to determine, for a given subset of the transportation requests a distance associated with traveling to pickup locations and destination locations associated with the given subset of the transportation requests.

19. The non-transitory computer readable storage medium of claim 15, wherein the instructions that, when executed by the at least one processor, cause the computer system to calculate the disutility metric for the first transportation request further cause the computer system to calculate a detour attributable to the first transportation request based on estimated service metrics corresponding to subsets of the transportation requests comprising the first transportation request.

20. The non-transitory computer readable storage medium of claim 15, further comprising instructions that, when executed by the at least one processor, cause the computer system to:
generate, using a machine-learning model for predicting disutility metrics and based on the estimated service metrics, a predicted disutility metric for the first transportation request of the shared transportation prior to completion of the shared transportation;
determine a difference between the predicted disutility metric for the first transportation request and the calculated disutility metric for the first transportation request; and
customizing the message based on the difference between the predicted disutility metric and the calculated disutility metric.
